(19) United States
(12) Patent Application Publication
(10) Pub. No.: US 2012/0249469 A1
(43) Pub. Date: Oct. 4, 2012

(54) Display with touch control function

(75) Inventors: Chin-Wen LIN, Miaoli County (TW); Chuan-I HUANG, Taipei City (TW); Henry WANG, HSINCHU (TW); Ted-Hong SHINN, Hsinchu City (TW)

(73) Assignee: E INK HOLDINGS INC., HSINCHU (TW)

(21) Appl. No.: 13/113,093

(22) Filed: May 23, 2011

(30) Foreign Application Priority Data
Apr. 1, 2011 (TW) 100111605

(51) Int. Cl. G06F 3/045; G06F 3/041

(52) U.S. Cl. 345/174; 345/173

(57) ABSTRACT

The present invention provides a display with touch control function. The display includes a touch panel module, a display module and a FPC board. The touch panel module includes a touch panel controller and a touch panel. The display module includes a display driver and a display panel. The touch panel is joined with the display panel. The FPC board couples with the display panel. The touch panel controller and the display driver are disposed on the FPC board.

### RELATED APPLICATIONS

This application claims priority to Taiwan Application Serial Number 100111605, filed Apr. 1, 2011, which is herein incorporated by reference.

### BACKGROUND

1. Field of Invention

The present invention relates to a display, and more particularly to a display with touch control function.

2. Description of Related Art

There are many kinds of touch panel module such as a resistive touch panel module and a capacitive touch panel module. The resistive touch panel module is composed of several layers, the most important of which are two thin, electrically conductive layers separated by a narrow gap. When an object, such as a finger, presses down on a point on the module outer surface the two metallic layers become connected at that point, and the module then behaves as a pair of voltage dividers with connected outputs. This causes a change in the electrical current, which is registered as a touch event and sent to the controller for processing. The capacitive touch panel module is one which consists of an insulator such as glass, coated with a transparent conductor such as indium tin oxide (ITO). As the human body touching the surface of the module results in a change in capacitance, a location of the touch is determined. The location is then sent to the controller for processing.

When a touch panel module is integrated into a display, the display can detect the presence and location of a touch within the display area. FIG. 1 illustrates a schematic diagram of a display with a touch panel module. The display 10 includes a touch panel module 100 and a display module 200. The touch panel module 100 and the display module 200 are joined together. The touch panel module 100 includes a flexible printed circuit (FPC) board 101, a touch panel controller 102 disposed in the FPC board 101 and a touch panel 103. The display module 200 includes a FPC board 201, a display driver 202 disposed in the FPC board 201 and a display panel 203.

According to this foregoing structure, the display 10 includes two FPC board 101 and 201 to dispose the touch panel controller 102 and the display driver 202 respectively. Such structure costs high.

### SUMMARY

An object of the present invention is to provide a display with a touch panel, wherein the touch panel controller and the display driver are disposed in a same FPC board to reduce the producing cost.

The present invention provides a display with touch control function. The display includes a touch panel module, a display module and a FPC board. The touch panel module includes a touch panel controller and a touch panel. The display module includes a display driver and a display panel. The touch panel is joined with the display panel. The FPC board couples with the display panel. The touch panel controller and the display driver are disposed on the FPC board.

In an embodiment, the display panel is an electronic paper display panel. The electronic paper display panel is an Electro-wetting display (EWD) panel, an electrophoresis display panel, a MEMS display panel or a Cholesteric Liquid Crystal display panel.

In an embodiment, the touch panel is a resistive touch panel, a capacitive touch panel or a Multi-touch panel.

In an embodiment, the touch panel is a four-wire resistance touch panel, a five-wire resistance touch panel, a six-wire resistance touch panel or a eight-wire resistance touch panel.

In an embodiment, the touch panel is joined with the display panel by a conductive adhering element. The conductive adhering element is a conductive glue. The conductive glue is an Anisotropic Conductive Film (ACF) or a metal film at least made by Ag, Au and Cu.

Accordingly, the touch panel is joined with the display panel by a conductive adhering element and the touch panel controller and the display driver are disposed on a same FPC board. Only a FPC board is used in the structure to locate the touch panel controller and the display driver. Therefore, the product cost is reduced.

### BRIEF DESCRIPTION OF THE DRAWINGS

In order to make the foregoing as well as other aspects, features, advantages, and embodiments of the present invention more apparent, the accompanying drawings are described as follows:

FIG. 1 illustrates a schematic diagram of a display with a touch panel module;

FIG. 2 illustrates a schematic diagram of a resistive touch panel module;

FIG. 3 illustrates a top view of a resistive touch panel module is integrated into an electronic paper display; and

FIG. 4 is a cross section view from the AA′ line in FIG. 3.

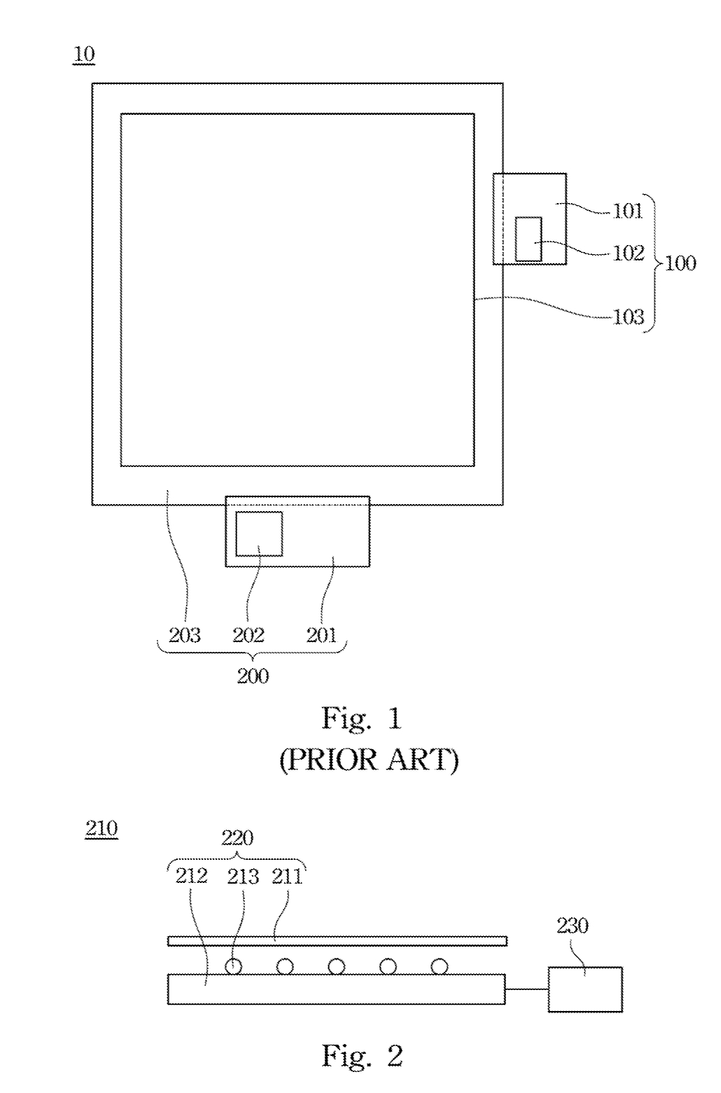

### DETAILED DESCRIPTION

Reference will now be made in detail to the present embodiments of the to invention, examples of which are illustrated in the accompanying drawings.

Wherever possible, the same reference numbers are used in the drawings and the description to refer to the same or like parts.

A typical display with a touch panel module needs two FPC board to dispose the touch panel controller and the display driver respectively. Such structure is against the cost control. Therefore, in the present invention, the touch panel is joined with the display panel by a conductive adhering element and the touch panel controller and the display driver are disposed on a same FPC board. That is, only a FPC board is used in the claimed structure to locate the touch panel controller and the display driver. Therefore, the cost is down. In the following embodiment, a resistive touch panel module is joined with a display panel to form an electronic paper display with touch control function. However, in other embodiments, other kinds of touch panel module, such as a capacitive touch panel or a Multi-touch panel, also can be used to join with a display panel to form an electronic paper display with touch control function. Moreover, the capacitive touch panel module is a Surface Capacitive touch panel module or a Projected Capacitive touch panel module.

FIG. 2 illustrates a schematic diagram of a resistive touch panel module. A resistive touch panel module 210 includes a touch panel 220 and a touch panel controller 230. The touch panel 220 includes a glass substrate 211 that is coated with electrically conductive, a resistive layer 211 made with indium tin oxide (ITO) and invisible spacers 213. The glass substrate 211 and the resistive layer 211 are separated by the invisible spacers 213. When something touches the resistive layer 211, the two separated sheets, glass substrate 211 and the in resistive layer 211, are pressed together. There are horizontal and vertical lines respectively formed on the glass substrate 211 and the resistive layer 211 to register the precise location of the touch when pushed together. Then, the touch panel controller 230 can determine the touch position. The resistive touch panel module is a four-wire resistance touch panel module, a five-wire resistance touch panel module, a six-wire resistance touch panel module or a eight-wire resistance touch panel module.

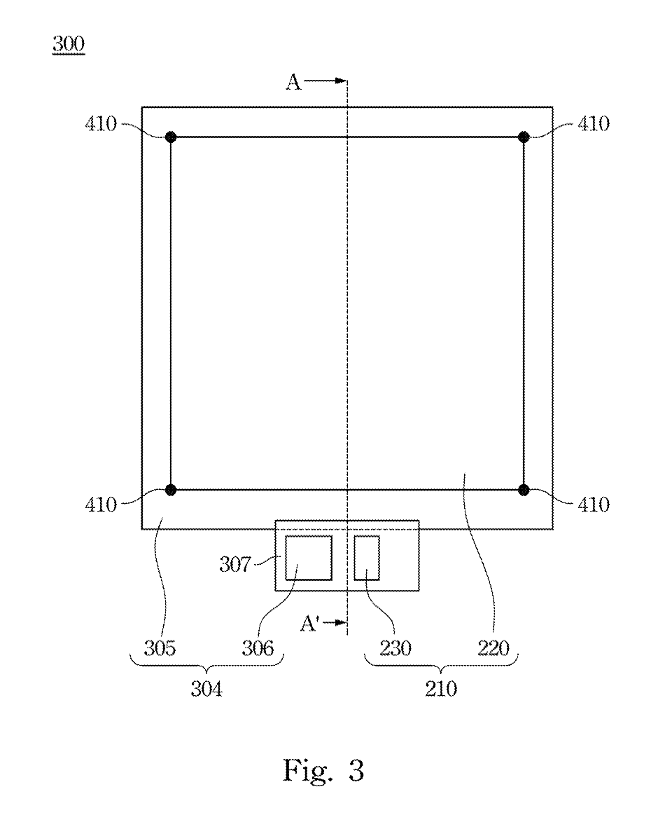

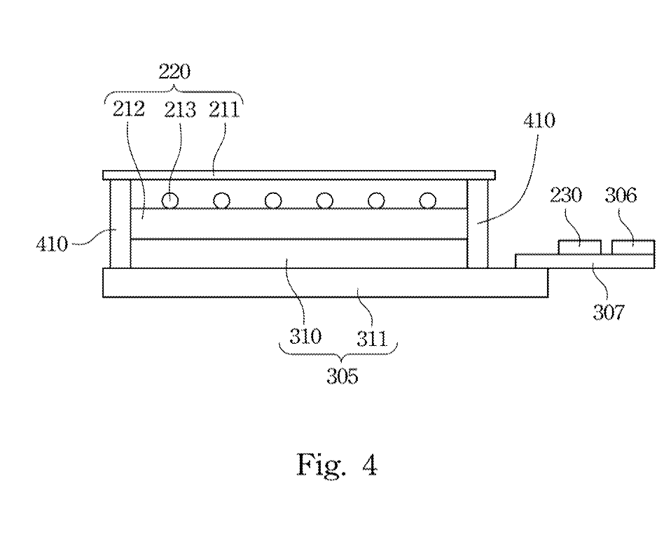

FIG. 3 illustrates a top view of a resistive touch panel module is integrated into an electronic paper display. FIG. 4 is a cross section view from the AA' line in FIG. 3. Please refer to FIG. 3 and FIG. 4.

The electronic paper display 300 with touch control function includes a touch panel module 210, a display module 304 and a FPC board 307. The touch panel module 210 includes a touch panel controller 230 and a touch panel 220. The display module 304 includes a display driver 306 and a display panel 305. The FPC board 307 couples with the display panel 305. The touch panel controller 230 and the display driver 306 are disposed on the FPC board 307. In an embodiment, the display panel 305 is an electrophoresis display panel including two substrates 310 and 311 and an electronic ink filled between the two substrates 310 and 311. In another embodiments, the display panel 305 is an Electro-wetting display (EWD) panel, a MEMS display panel or a Cholesteric Liquid Crystal display panel. According to the present invention, the touch panel controller 230 and the display driver 306 are disposed on a same FPC board 307. That is, comparing with the typical display with touch control function structure, only a FPC board is used in the present invention to locate the touch panel controller 230 and the display driver 306. Therefore, the product cost is reduced.

Moreover, the touch panel 220 is joined with the display panel 305 by a conductive adhering element 410. The conductive adhering element 410 is a conductive glue. The conductive glue is an Anisotropic Conductive Film (ACF) or a metal film at least made by Ag, Au and Cu. By the conductive adhering element 410, the circuit layout between the touch panel 220 and the touch panel controller 230 is disposed on the substrate 311 of the display panel 305. In other words, this circuit layout between the touch panel 220 and the touch panel controller 230 is formed together with the circuit layout between the display panel 305 and the display driver 306.

Moreover, as shown in the FIG. 4, the conductive adhering element 410 can be disposed on the four corners of the touch panel 220. Accordingly, when the touch panel module 410 is a four-wire resistance touch panel module, the four detecting lines disposed on the touch panel 220 can couple with the four conductive adhering elements 410 respectively. Then, the four detecting lines can be led to the substrate 311 through the conductive adhering elements 410 respectively to connect to the touch panel controller 230 on the FPC board 307.

Accordingly, the touch panel is joined with the display panel by a conductive adhering element and the touch panel controller and the display driver are disposed on a same FPC board. Only a FPC board is used in the structure to locate the touch panel controller and the display driver. Therefore, the product cost is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display with touch control function, comprising:
a touch panel module, wherein the touch panel module includes a touch panel controller and a touch panel;
a display module, wherein the display module includes a display driver and a display panel, and the touch panel is joined with the display panel; and
a FPC board, wherein the FPC board couples with the display panel, and the touch panel controller and the display driver are disposed on the FPC board.

2. The display of claim 1, wherein the display panel is an electronic paper display panel.

3. The display of claim 1, wherein the electronic paper display panel is an Electro-wetting display (EWD) panel, an electrophoresis display panel, a MEMS display panel or a Cholesteric Liquid Crystal display panel.

4. The display of claim 1, wherein the touch panel is a resistive touch panel, a capacitive touch panel or a Multi-touch panel.

5. The display of claim 1, wherein the touch panel is a four-wire resistance touch panel, a five-wire resistance touch panel, a six-wire resistance touch panel or a eight-wire resistance touch panel.

6. The display of claim 1, wherein the touch panel is joined with the display panel by a conductive adhering element.

7. The display of claim 1, wherein the conductive adhering element is a conductive glue, the conductive glue is an Anisotropic Conductive Film (ACF) or a metal film comprising Ag, Au and Cu.

8. The display of claim 1, wherein the conductive adhering element is formed on the four corners of the touch panel.
